(19) United States
(12) Patent Application Publication
(10) Pub. No.: US 2005/0055307 A1
(43) Pub. Date: Mar. 10, 2005

(54) Online subordination website

(76) Inventor: Alexander Vera, Davie, FL (US)

Correspondence Address: ALEXANDER VERA, 2881 SW 73 WAY, APT 2106, DAVIE, FL, 33314, US

(21) Appl. No.: 10/889,151

(22) Filed: Jul. 13, 2004

Related U.S. Application Data
(60) Provisional application No. 60/488,047, filed on Jul. 18, 2003.

(51) Int. Cl. G06F 17/60

(52) U.S. Cl. 705/38

(57) ABSTRACT

A website which allows users who need a lien or mortgage loan to be subordinated to the next lien holder position paperless through means of online website submission forms, document uploaders and allows the financial institutions to receive payment for the subordination fee as well as other services electronically through direct deposits and money transfers via online internet connections. This process also allows financial institutions to begin receiving their subordination applications along with the pertinent documents required to subordinate a lien or loan (i.e., 1003 Uniform Residential Application, Appraisal, Deed of Trust) via electronics mean through a website connection or internet connection, as well as receiving payments for such subordination fees. The website also contains a database that allows users to look up current subordination requirements as well as the financial institution's contact address, phone number, fee, requirements.

This application claims priority as it was filed as a provisional patent on Jul. 18, 2003 Application No. 60/488,047 confirmation number 9981. This invention relates generally to computer network data operations and, more particularly, to an apparatus for receiving subordination requests, generating and updating databases for the retrieval of information and allowing financial institutions access to receiving subordination requests and pertinent documentation as well as payments electronically and via online access as well as the user to submit such subordination requests electronically and through online means.

### FIELD OF THE INVENTION

### BACKGROUND OF THE INVENTION

The internet is a seamless array of information and has allowed millions of users the opportunity of convenience. There has been many applications that have added a modern convenience for many people such as online banking, online bill payments, online shopping to name a few. The mortgage industry has even gotten into the act by allowing those who surf onto their websites the opportunity to fill out forms to apply for mortgages as well as submit title searches. Such sites like Wintrack.com, RadianExpress.com and RealEc.com allow mortgage companies the ease of submitting title property search requests via online access.

There has not been an invention yet that allows a user or mortgage company to electronically submit a request for subordination of a lien or loan. Thus, this invention has been created and should be noted as the first of its kind. The creation of the internet and more so of this invention, allows what once was a complex submission process easy. Before, a subordination request would have to require the borrower or the mortgage company to acquire the correct subordination requirements such as submitting the 1003 Uniform Residential Loan Application, Appraisal, 1008 Underwriter's Form along with a copy of the current title showing the lien and a check for such said subordination fee. These documents would have to be mailed originally to the financial institution and/or mortgage company in an attempt to subordinate such lien or loan on title. Such invention allows the user to do this all electronically without having to mail any documentation to such organization. The invention is best demonstrated on the site http://www.subordinating.com which is where the invention is being used currently. Additionally, this application claims priority as it was filed as a provisional patent on Jul. 18, 2003 Application No. 60/488,047 confirmation number 9981.

The financial institution can receive such said documentation and fees electronically without having to wait for mail services such as UPS, FedEx or the U.S. Mail to deliver such said documentation. The financial institution or mortgage company can receive such said documents instantly and view information, print information and receive payment electronically as well as post the results online for the user to access.

### BRIEF SUMMARY OF THE INVENTION

An online subordination website which allows users who need a lien or mortgage loan to be subordinated to the next lien holder position paperless through means of online website submission forms, document uploaders and allows the financial institutions to receive payment for the subordination fee as well as other services electronically through direct deposits accesses via online internet connections. This process also allows financial institutions to begin receiving their subordination applications along with the pertinent documents required to subordinate a lien or loan (i.e., 1003 Uniform Residential Application, Appraisal, Deed of Trust) via electronics mean through a website connection or internet connection. Also a computer system for creating or updating a database of online subordination requirements and related documents, said computer system comprising a central processing unit that can establish communication with a network of documents; and a program memory that stores programming instructions executed by said central processing unit, wherein said computer system executing said programming instructions performs a process comprising,
a) entering at least one example document that is relevant to a subject taxonomy in a retrieval priority list, locating by relevancy
b) retrieving such said document from a network of documents based on relevancy;
c) harvesting information from specified fields of said document;
d) storing said information into a database;
e) determining whether said information are links to other documents;
f) ranking information according to relevancy to said subject taxonomy, and storing said links in said retrieval priority list according to said relevancy;
g) terminating said method, provided said method's stop criteria have been met; and
h) repeating steps b) through h), provided said method's stop criteria has not been met.

5. The method of claim 4 further comprising:
a) receiving information;
b) applying the information to the subject taxonomy of the database.

### BRIEF DESCRIPTION OF THE DRAWINGS

FIG. 1 is the main page of the website that illustrates what such said invention can provide and options available for the user.

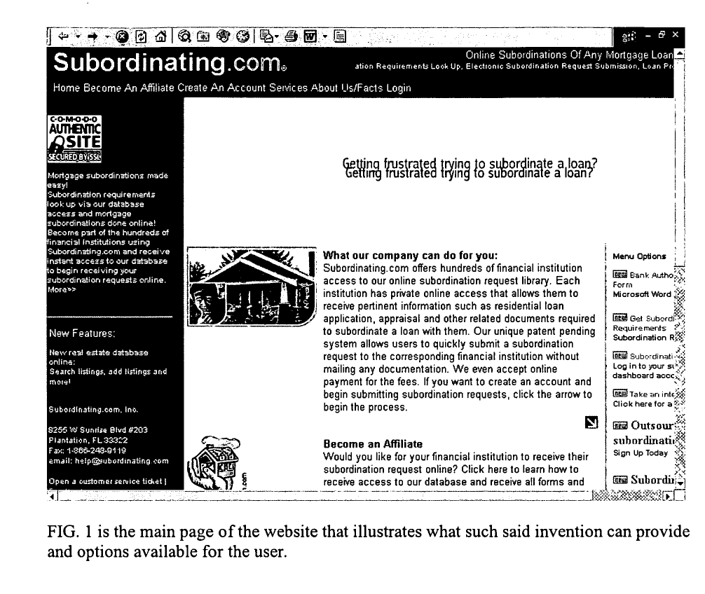

FIG. 2 is the quick subordination application form that users fill out to submit a subordination request.

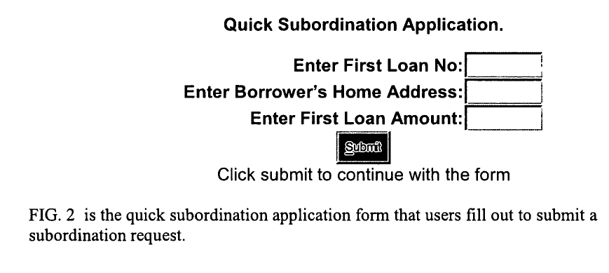

FIG. 3 illustrates the uploader form in which the user can upload documents.

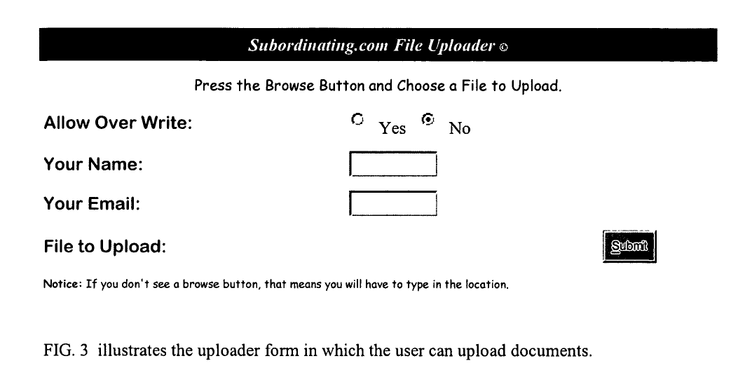

FIG. 4 illustrates the area in which a user can track the status of a subordination request in progress.

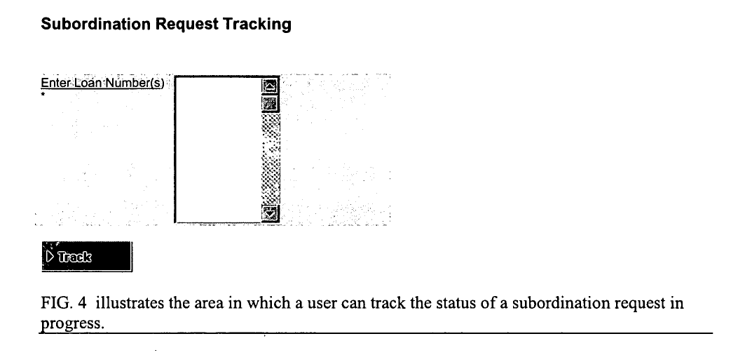

FIG. 5. shows the subordination requirements look up database that allows the user to search for subordination requirements specific to financial institutions and mortgage companies.

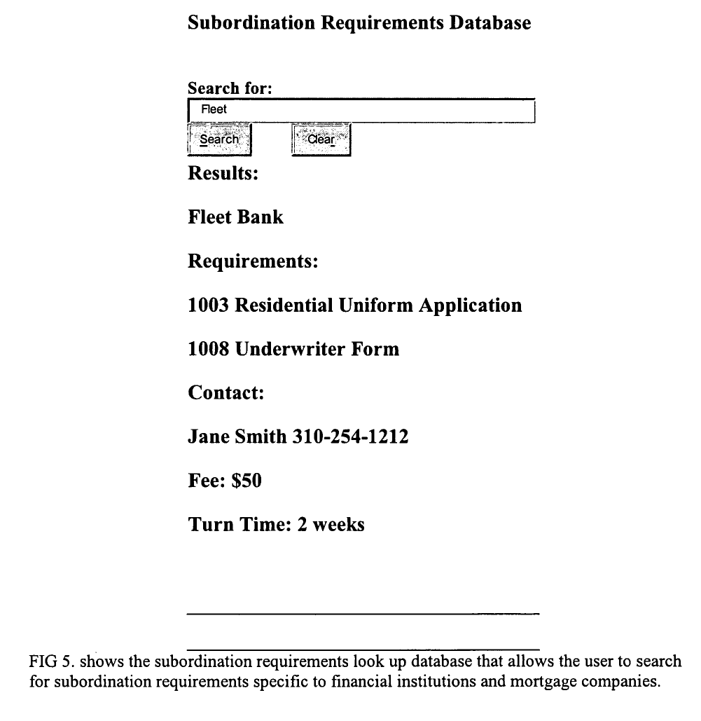

### DETAILED DESCRIPTION

Terms and Definitions

As used herein the term, “subordination” refers to a written agreement between holders of liens on a property that changes the priority of mortgage, judgment and other liens under certain circumstances. Also known as a subordination agreement.

As used herein the term “uploader” refers to an html source code script that allows documents such as, but not limited to, Microsoft Word Documents, Acrobat Reader Documents to be attached and sent to a network of computers, servers, emails and/or documents.

As used herein the term, “form” refers to an online form html source code script that allows user to fill out information as one would with a manual application, but done electronically online.

As used herein the term, “website” refers to a collection of one or more electronic files, mainly Webpages, available to viewers via the Internet. Viewers must use a web browser to successfully view websites.

As used herein the term, “online” refers to being under the control of a central computer, as in a manufacturing process or an experiment. b. Connected to a computer or computer network. c. Accessible via a computer or computer network, ex., an online database.

As used herein the term, “title” refers to a document that shows ownership of real property to the exclusion of anyone else's right to claim the property. Evidence of title is recorded in a deed and held in a county recorder's office. The terms “title” and “deed” often are used interchangeably; strictly speaking, the deed is the document and the title is the ownership right that is recorded in the deed.

As used herein the term, “subordination requirements” refers to requirements specific to financial institutions and mortgage companies required to subordinate a lien held on title. These requirements include documents needed to be supplied as well as, but not limited to, contact names, numbers and addresses.

1. An online subordination website which allows users who need a lien or mortgage loan to be subordinated to the next lien holder position paperless through means of online website submission forms, document uploaders and allows the financial institutions to receive payment for the subordination fee as well as other services electronically through direct deposits and money transfers via online internet connections. This process also allows financial institutions to begin receiving their subordination applications along with the pertinent documents required to subordinate a lien or loan (i.e., 1003 Uniform Residential Application, Appraisal, Deed of Trust) via electronics mean through a website connection or internet connection.

2. An online subordination website as defined in claim 1, wherein the applicants who visit the website can (1) Create a membership account that allows them access to thousands of mortgage companies and financial institutions online (2) The ability to access a user form that: (A) Allows user to enter Financial Institution To Subordinate Loan With (B) Enter that specific Loan Amount (C) Enter the original first loan amount (D) Select second lien product type (E) Asks if this loan subject to negative amortization (F) Asks if this loan an adjustable rate to fixed rate refinance (G) Asks if loan is a cash out (H) Asks for the Original second loan amount (I) Asks if this loan is a fixed rate to fixed rate refinance (J) Asks for borrower specific information such as, First name, last name, social security number, driver's license number, date of birth, home address, email address (K) Asks for property information such as Property address, estimated property value, amount financed, payment and appraisal date.

3. An online subordination website as defined in claim 1 & 2, wherein the website visitor can open an account to place subordination requests to subordinate a lien or mortgage loan held on title or deed of trust via online website access and allows the financial institution to receive such documentation that the user has submitted through electronic means (1) by allowing the financial institution or mortgage company to receive such documentation online for them to view instantly, i.e., they can view a copy of the borrower's 1003 Uniform Residential Loan Application and other pertinent documents needed to submit a subordination (2) receive the user form that borrower submitted as referenced in claim 2 sections A, B, C, D, E, F, G, H, I, J, K. (3) Receive payment by means of credit card, check, electronic debit, pay pal, or any other virtual or non virtual electronic payments means, sent to the financial institution or mortgage companies banking account (4) Allows the financial institution or mortgage company to review all material sent to them and allows them to make a determination to subordinate or not subordinate the lien or mortgage loan.

4) An automated method of creating or updating a database of subordination requirements, fees, addresses, contact names, telephone numbers and faxes and related documents from a network of documents, for the user to look up and retrieve such said subordination requirements as a said method comprising:
a) entering at least one example document that is relevant to a subject taxonomy in a retrieval priority list, locating by relevancy
b) retrieving such said document from a network of documents based on relevancy;
c) harvesting information from specified fields of said document;
d) storing said information into a database;
e) determining whether said information are links to other documents;
f) ranking information according to relevancy to said subject taxonomy, and storing said links in said retrieval priority list according to said relevancy;
g) terminating said method, provided said method's stop criteria have been met; and
h) repeating steps b) through h), provided said method's stop criteria has not been met.

5. The method of claim 4 further comprising:
a) receiving information;
b) applying the information to the subject taxonomy of the database.

6. A computer system for creating or updating a database of online subordination requirements and related documents, said computer system comprising a central processing unit that can establish communication with a network of documents; and a program memory that stores programming instructions executed by said central processing unit, wherein said computer system executing said programming instructions performs a process comprising,
a) entering at least one example document that is relevant to a subject taxonomy in a retrieval priority list, locating by relevancy
b) retrieving such said document from a network of documents based on relevancy;
c) harvesting information from specified fields of said document;
d) storing said information into a database;
e) determining whether said information are links to other documents;
f) ranking information according to relevancy to said subject taxonomy, and storing said links in said retrieval priority list according to said relevancy;
g) terminating said method, provided said method's stop criteria have been met; and
h) repeating steps b) through h), provided said method's stop criteria has not been met.

6. An online subordination website as defined in claim 1 & 2, wherein a financial institution, bank, mortgage company can create an account, receive payment for fees, have access to receiving online documents, have access to receive information submitted via means of electronic forms, submit information back to main website to post for user to view, allow subordination of lien or mortgage loan on title electronically or by non-electronic means, email information and submit transmittals electronically to financial institutions and mortgage companies to subordinate lien or mortgage loan held on title electronically update, change, add to, delete thereof information in subordination requirement database and information on title. Also electronically submit changes on title to title companies and make instant changes on the title as to the lien holder position on title.

7. An online subordination website, that allows the user who surfs onto the appropriate website to create a profile containing their personal information, allows the user to upload documents in a document uploader section comprised of html source code to upload specific documentation, allows the user to track the progress of the subordination request submitted and allows the user to know the status of the subordination and to whether or not it was accepted, rejected, incomplete as well as view, download or print said subordination.

8. An online subordination website that contains 50 United States compliant subordination forms for the user to download or complete manually or electronically to submit a subordination request, a database that contains multiple financial institution subordination request coversheets, work sheets and forms needed and are financial/mortgage institution specific forms required to subordinate such lien or mortgage loan held by such financial institution or mortgage company.
